(19) United States
(12) Patent Application Publication
(10) Pub. No.: US 2014/0129661 A1
(43) Pub. Date: May 8, 2014

(54) Smart Web Notifications

(71) Applicant: Somas THYAGARAJA, San Francisco, CA (US)

(72) Inventor: Somas THYAGARAJA, San Francisco, CA (US)

(21) Appl. No.: 13/669,749

(22) Filed: Nov. 6, 2012

(51) Int. Cl. G06F 15/16

(52) U.S. Cl. 709/207

(57) ABSTRACT

Methods and systems that provide browser notifications are provided. A plurality of communication channels are established between a client device and one or more servers. The plurality of communication channels are associated with a plurality of notification sources for a web application. One or more notifications from the plurality of notification sources are identified. An importance score is generated for each of the one or more identified notifications. An importance score is generated based on a characteristic of a user's interactions with the client device. The one or more notifications are displayed in a viewing area of the client device. The importance score determines an order of display and duration of display for each notification.

### BACKGROUND

1. Field

Embodiments are generally related to an application or service that receives, aggregates, and displays notifications.

2. Background

A notification system provides a means of delivering a message to a recipient. A user of a web-based application, such as a browser, may register to receive updates from different websites. In one example, when a user is viewing the contents of an active browser tab, updates to a non-active browser tab may occur. For example, the non-active browser tab may receive automatic page refreshes, which result in an update of the browser tab. In general, a user may be unaware of these updates while viewing an active tab. Recently, some browsers have included functionality to help a user become aware of updates to non-active browser tabs. Such methods include causing the tab of a non-active browser tab to flash whenever the content for that tab has changed. Additional techniques include websites providing notifications to the user. Such notifications are generally in the form of a small pop-up window that is displayed and alerts the user of new content and then disappears.

In another example of a notification system, a user may receive updates via Really Simple Syndication (RSS) feeds. An RSS feed is a web-based format utilized to publish updates for various web-based information sources such as social network, blog or news-based websites. An RSS feed includes a full or summarized text of an update. A publisher of an RSS feed may provide automatic updates to subscribers by, for example, utilizing a standard XML file format which allows the update information to be published once and viewed by many different subscribers. Subscribers to RSS feeds generally use an RSS reader to view RSS feed updates. The RSS reader is specialized software that is configured to check a subscriber's RSS feeds for information updates. The subscriber may then examine the RSS feed updates via a user interface of the RSS feeder.

Existing notification systems have certain drawbacks which detract from the overall user experience. For example, with present techniques, a user has to perform different operations in order to determine the contents of an update. For example, a user may have to navigate away from a currently viewed browser tab in order to see the updates provided by another website. Additionally, since there are a number of different kinds of notification systems, a user may have to utilize several different programs or user interfaces in order to view different kinds of updates or notifications from various information sources. Further, in order to receive updates from a notification system, a user has to manually subscribe or register to receive updates. For cases in which there exist additional information sources that a user may be interested in knowing about, the user must seek that information on their own.

For example, W3C notifications (web standard) allow a website to register for notifications and push new notifications to the user through the browser. However, this is quite limited because (i) the website has to be open all the time (as an open tab) in order to send notifications and (ii) it is shown outside the browser and the behavior of notifications varies between different operating systems.

With respect to RSS feeds, a user can install browser extensions that allow the user to specify all the RSS feeds of interest. An RSS reader then aggregates and displays all these feeds as a single feed. However, the system is limited only to those websites that provide RSS feeds.

### BRIEF SUMMARY

Embodiments described herein relate to methods and systems for receiving, aggregating and displaying notifications. A plurality of communication channels are established between a client device and one or more servers. The plurality of communication channels are associated with a plurality of notification sources for a web application. One or more notifications from the plurality of notification sources are identified. An importance score is generated for each of the one or more identified notifications. An importance score is generated based on a characteristic of a user's interactions with the client device. The one or more notifications are displayed in a viewing area of the client device. The importance score determines an order of display and duration of display for each notification.

Further embodiments, features, and advantages of the invention, as well as the structure and operation of the various embodiments of the invention are described in detail below with reference to accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram illustrating an example system, according to an embodiment.

FIG. 2 is an illustration of a browser, according to an embodiment.

FIG. 3 is an illustration of an example display view of an exemplary system, according to embodiment.

FIG. 4 is a flow diagram of an example method of operation, according to embodiment.

FIG. 5 is another flow diagram of an example method of operation, according to embodiment.

FIG. 6 is a diagram of an example system that may be used to implement embodiments disclosed herein.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Notification systems provide users with updates to content for different kinds of notification sources. An application, as described herein, allows its users to receive, aggregate and display notifications from different kinds of notification sources. In an example use of such an application, a user may subscribe or register to receive notifications from a plurality of different kinds of notification sources. A notification source is a supplier of content or information. In general a user subscribes or registers to receive updates from a notification source, such as, but not limited to, a website. In response to the subscription or registration, the notification source provides an indication of updated content to the user. For example, a user may subscribe to a website that provides a Really Simple Syndication (RSS) feed. Such a website may be, for example, a news-based website. When the content of the news-based website is updated, the website publishes the new content and the user is able to receive the RSS feed indicating that there is new content. The application can extract the information from an RSS feed update and generate a notification for the user which is displayed in a viewing area of a web-based application. A notification is a descriptive summary of the contents that have been updated by a notification source. A notification provides a user with sufficient detailed information about an update, so that a user is adequately aware of the information contained within the update prior to navigating to the notification source associated with the notification. Alternatively, a user may navigate to a particular website and select an option to receive notifications from the website. The website may then generate a notification when the content of the website is updated and push the notification from a server running the website to the client device of the user.

When notifications are generated or received from the notification sources, all the notifications may be aggregated and stored in a database at a client device. An importance score may be generated for each notification in the database. The importance score is based on a characteristic of a user's interactions with the client device. For example, the frequency of usage or daily pattern of use of a notification source by a user may be used to generate an importance score for a notification. The importance score is an indication of how likely a user desires to view notifications from a particular notification source. The notifications in the database may be displayed to the user based on the associated importance score. The importance score determines an order of display and duration of display for each notification. In this way, the user may view different kinds of notifications or updates received from different notification sources in a central location and at a desired time.

It is noted that the embodiments are not limited to this example application, but are instead applicable to other applications as would be apparent to persons skilled in the art based on the teachings provided herein. Those skilled in the art with access to the teachings provided herein will recognize additional modifications, applications, and embodiments within the scope thereof and additional fields in which the embodiments would be of significant utility. For example, an individual may have their browser window completely minimized and running as a background process while working with another application on a computing device. In such an example, notifications may continue to be received or generated, aggregated and presented to the user once the browser window is accessed or maximized. For instance, the browser can also choose to display incoming notifications outside the browser window (e.g. on the desktop) when it is minimized so the user can still view and act on them without having to maximize the browser window.

It would also be apparent to one of skill in the relevant art that the embodiments, as described herein, can be implemented in many different embodiments of software, hardware, firmware, and/or the entities illustrated in the figures. Any actual software code with the specialized control of hardware to implement embodiments is not limiting of the detailed description. Thus, the operational behavior of embodiments will be described with the understanding that modifications and variations of the embodiments are possible, given the level of detail presented herein.

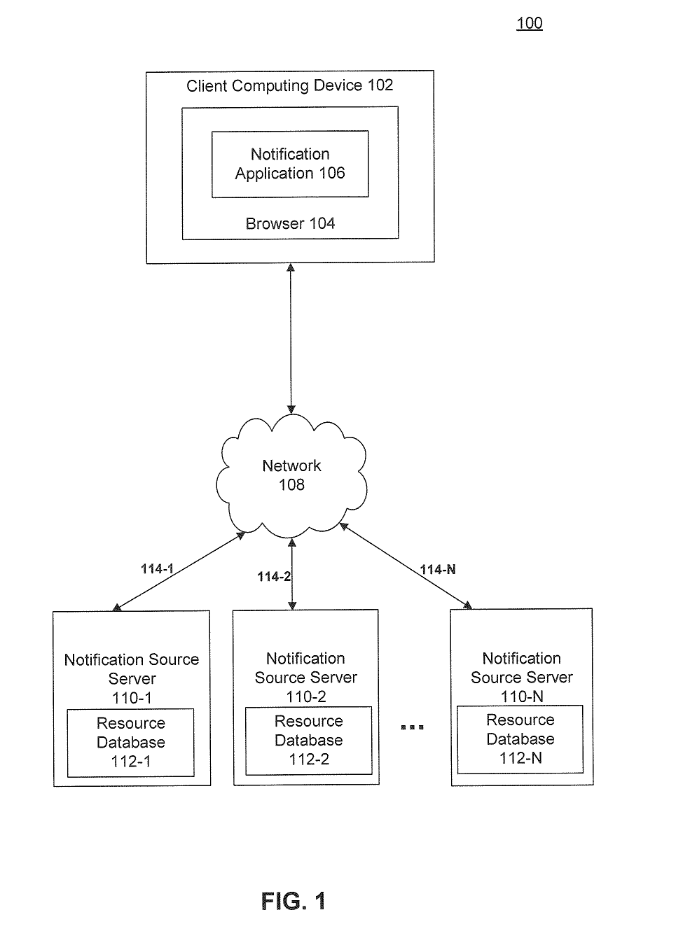

FIG. 1 is a block diagram illustrating a notification system 100 for receiving, aggregating, and displaying notifications. Notification system 100 includes a client computing device 102 and one or more notification source servers 110-1, 110-2 . . . 110-N, N being a positive integer. Client computing device 102 and the one or more notification source servers 110-1, 110-2 . . . 110-N are coupled via one or more networks 108, such as the Internet or other wide area or local area network. Notification source servers 110-1, 110-2 . . . 110-N include resource databases 112-1, 112-2 . . . 112-N. Client computing device 102 communicates with notification source servers 110-1, 110-2 . . . 110-N through a plurality of communication channels 114-1, 114-2 . . . 114-N. Client computing device 102 includes a browser 104.

Browser 104 may be any kind of browser. Browser 104 includes a notification application 106. Notification application 106 may extend the functionality of browser 104 and can be configured to receive, aggregate, and display notifications from different notifications sources. Notification application 106 may be a browser extension downloaded from a web server (not shown) and installed on client computing device 102 as part of browser 104. Notification application 106 may be developed by an application developer for use on client computing device 102 or any other computing device. A programming language, such as JavaScript, may be used to develop browser notification application 106. Notification application 106 may then be stored locally on client computing device 102. Alternatively, notification application 106 may be uploaded to a notification manager server (not shown). Notification manager server may distribute notification application 106 to additional client computing devices due to a request from a user.

In general, browser notification system 100 operates as follows. Browser 104 establishes communication with one or more notification source servers 110-1, 110-2 . . . 110-N via network 108 and plurality of communication channels 114-1, 114-2 . . . 114-N. Communication with one or more notification source servers 110-1, 110-2 . . . 110-N is established in response to a user subscribing or registering to receive notifications about content updates associated with the notification source servers 110-1, 110-2 . . . 110-N. When new content is generated by notification source servers 110-1, 110-2 . . . 100-N, each notification source server 110-1, 110-2 . . . 100-N generates an indication of the new content. The indicator of the new content can be formatted as a notification which is sent to the client computing device 102. A notification is a message which can include a descriptive title and summary of the new content generated by notification source servers 110-1, 110-2 . . . 110-N.

Notification source servers 110-1, 110-2 . . . 110-N are computing devices or applications executing on computing devices that host resource databases 112-1, 112-2 . . . 112-N. Each resource database 112-1, 112-2 . . . 112-N is associated with a domain name and hosted by one or more notification source servers 110-1, 110-2 . . . 110-N. Notification source servers 110-1, 110-2 . . . 110-N deliver content from resource databases 112-1, 112-2 . . . 112-N to browser 104 on client computing device 102. Content included in resource databases 112-1, 112-2 . . . 112-N includes any data that that can be provided over network 108. Content within resource databases 112-1, 112-2 . . . 112-N is identified by a resource address that is associated with each notification source server 110-1, 110-2 . . . 110-N. Content in resource databases 112-1, 112-2 . . . 112-N may include, for example, hypertext markup language (HTML) pages, word processing documents, portable document format (PDF) documents, images, video, and feed sources. Content in resource databases 112-1, 112-2 . . . 112-N can also include content, such as words, phrases, images and sounds, that has embedded information (such as meta-information in hyperlinks) and/or embedded instructions (such as JavaScript scripts).

According to an embodiment, a user may receive a notification from a notification source supported by a notifications application programming interface (API). A notifications API allows a developer to develop a notification source, such as a webpage, that displays notifications to a user for given events (e.g. change in content). The notifications API is a specification intended to be used as an interface between browser 104 and notification source servers 110-1, 110-2 . . . 110-N. The notifications API can include specifications for routines, data structures, object classes, and variables. For example, a website developer may develop a notification source whose contents are stored at notification source servers 110-1, 110-2 . . . 110-N, where the notification source leverages the notifications API.

To determine if a notification source is supported by the notifications API, the developer must include a notifications API indicator in the source code of the notifications source. The notifications API indicator may be a flag defined by the notifications API. The flag may be included as part of a response message sent by notification source servers 110-1, 110-2 . . . 110-N when a user requests content from notification source servers 110-1, 110-2 . . . 110-N. For example, when a developer sets the notifications API indicator flag to 1, notification application 106 is able to identify that the notification source is supported by a notifications API. Notification application 106 can then examine the corresponding communication channels 114-1, 114-2 . . . 114-N for notifications sent from notification source servers 110-1, 110-2 . . . 110-N. Upon receipt of a response message from notification source servers 110-1, 110-2 . . . 110-N, browser 104 can parse the contents of the requested notification source and check the notifications API indicator flag, according to an embodiment.

To generate notifications using the notifications API, the developer may need to include code within the source code that determines whether a user has enabled notifications to be received. For example, the notifications API may include a notifications enabled function. The notifications enabled function may be a simple routine that sets a permissions flag indicating that a user permits notifications to be sent for the notification source. For example, the developer can associate the notifications enabled function with an object of a web page, such as a button embedded in a web page displayed by browser 104. When a user selects the button, an event will be generated and the permissions flag will be set to enabled. This is an indication that the user has registered to receive notifications from the notifications source. Furthermore, a developer may then leverage a create notifications method of the notifications API. In the source code, a developer may include code having a loop that generates a notification whenever there is new content for the notification source. Thus, whenever new content for the notification source is generated, the create notifications method can be called, and a notification can be created and sent to browser 104.

As discussed above, an example of a notification source is a web page. A user of browser 104 can navigate to the webpage by entering a URL corresponding to a particular web page in an address field of browser 104. For instance, a user may input the HTTP protocol (e.g. “http”) and a notification source server name (e.g. “www.websitetodisplay.com”). When the user enters the notification source server name, the corresponding IP address is determined. In general, an IP address corresponding to a notification source server name is determined by a domain name server (DNS) (not illustrated). The DNS maps the notification source server name to an IP address. When a user enters a URL, the notification source server name is passed to the DNS, which looks up the corresponding IP address for the notification source server associated with the URL. Browser 104 submits an HTTP request message to the notification source server 110-1, 110-2 . . . 110-N corresponding to the server name. The HTTP request message can include an encrypted user identification (ID), according to an embodiment. The encrypted user ID can include information identifying the user, such as an IP address associated with the client computing device 102. Notification source servers 110-1, 110-2 . . . 110-N can use the encrypted user ID to target a specific user and send notifications to the user. Notification source servers 110-1, 110-2 . . . 110-N provide resources such as web-based files and other content, or perform other functions on behalf of browser 104 and return a response message to browser 104. The response message includes completion status information about the request and may also include requested content retrieved from resource databases 112-1, 112-2 . . . 112-N. When the response message is received, browser notification application 106 establishes a communication channel 114-1, 114-2 . . . 114-N. Communication channels 114-1, 114-2 . . . 114-N enable the exchange of messages and content between browser 104 and the one or more notification source servers 110-1, 110-2 . . . 110-N. Browser 104 reads the response message and formats the content to be displayed by browser 104.

In an embodiment, an update to content of a notification source results in the generation of a notification from notification source servers 110-1, 110-2 . . . 110-N. The notification is sent to browser 104 via communication channels 114-1, 114-2 . . . 114-N. In an embodiment, browser notification application 106 receives a notification sent by a notification source supported by a notifications API. Browser notification application 106 can examine the communication channels 114-1, 114-2 . . . 114-N of those notification sources that are supported by a notifications API. When such a notification source provides new content and generates a subsequent notification by calling the requisite notifications API functions, browser notification application 106 can receive the notification. In an embodiment, a notification generated by a website supported by a notifications API is formatted with a notifications title and notifications summary. Thus, browser notification application 106 receives the notification and displays the notifications in a viewing area. A notifications title can indicate the URL associated with a browser tab, for instance. A notifications summary is a short description describing the kind of update received. Thus, a notification can be generated indicating which notification source sent the notification, along with a description of the content that was received. For example, a notification generated by browser notification application 106 may include the URL of an email website as the notifications title, along with a couple of lines of text that provide a summary of the new email message which has been received. The notifications summary may include the time, sender, and subject line of the new email, for example.

According to another embodiment, a user may be provided with a notification in response to a Really Simple Syndication (RSS) feed of a notification source. RSS is an Extensible Markup Language (XML) based technique for requesting, from a notification source (e.g. web site), a list of recent changes (e.g. the feed). RSS allows a notification source to publish information about recent changes to content that resides at notification source servers 112-1, 112-2 . . . 112-N. In an embodiment, an RSS feed is an XML document that is made available to client computing device 102 by notification source servers 110-1, 110-2 . . . 110-N and is associated with a URL. The XML document can include a list of all changes to a notification source or a change to a specific section of the notification source. The XML document can include general information about the RSS feed itself, and also include a list of items, which represent recent modifications to the notification source. Each item can include a descriptive title, a link to the document residing at notification source servers 110-1, 110-2 . . . 110-N, and a summary of the recent change in the document. In this way, an RSS feed allows a user to become aware of new information published by a notification source, without having to regularly visit or search the notification source. For example, RSS feeds can be used for websites that provide chronologically based information, such as news-based websites, blogs, and social media websites.

When a user navigates to a website that provides RSS feeds, an option to subscribe to receive the RSS feeds can be presented. In response to subscribing to receive RSS feeds from a notification source, notification application 106 examines communication channels 114-1, 114-2 . . . 114-N for updates of content from notification source servers 110-1, 110-2 . . . 110-N. Notification application 106 can check the RSS feed documents for all notification sources for which a user has subscribed to receive RSS feeds, according to an embodiment. When new information is detected, notification application 106 can extract information from the RSS feed document and generate a notification for the user. The notification informs the user of new content from a notification source associated with an RSS feed subscription.

Notifications application 106 can be configured to identify one or more notifications received from notification source servers 110-1, 110-2 . . . 110-N. In response to a receipt of notifications from a notification source supported by a notifications API or the generation of a notification from a notification source with a RSS feed, notifications application 106 can store the notifications in a notifications database (not shown). The notifications are stored in the notifications database prior to being presented or displayed to the user on client computing device 102. According to an embodiment, an importance score can be generated for each of the one or more notifications received or generated. An importance score is a value which indicates a probability of a user's desire to view notifications from a particular notification source. For example, an importance score for a notification can be in a range between 1% and 100%, where 100% indicates the user has a high desire to view notifications from a notifications source and 1% indicates the user probably does not want to see notifications displayed by that particular notification source.

The generation of an importance score for a notification can be based on a model. According to an embodiment, a model determines an importance score based on a characteristic of a user's interaction with client computing device 102. Based on the model and a set of criteria, an importance score for each notification within the notifications database is determined and the notifications may be displayed to the user in an order and for a duration based on the importance score. A standard machine learning or statistical technique may be used to generate an importance score or the probability that a user desires to see a notification from a notification source. Machine learning includes using various algorithms that take as input empirical data, such as the user's interaction with the client computing device 102, and output an indication of patterns or predictions of future user activity. According to an embodiment, notification application 106 is configured to generate a model based on a set of criteria. Criteria are based on at least one of the following: (i) information related to the characteristic of the user interaction with the client computing device, (ii) a preconfigured user setting, and (iii) a prior user selection of a notification. Generation of the model and importance scores are discussed in greater detail below.

As discussed above, characteristics of the user interaction with the client computing device 102 can determine which notifications are displayed to a user, an order in which the notifications are displayed to a user, and a duration for which the notifications are displayed to the user. According to an embodiment, characteristics of the user interaction with the client computing device can include a visitation frequency to a notification source, a visitation pattern to a notification source, a clickthrough rate for notifications associated with a notification source or a state of a web application based on a user's most recent interaction with the web application. For example, browser 104 can analyze and maintain a log of the notification sources most frequently visited by a user within a predetermined time interval. Notification application 106 can then be configured to give priority to notifications received from the most frequently visited notification sources. Thus, in this example, notification application 106 can display these notifications to a user at the beginning of a list of notifications and for a significant duration longer than notifications from less frequently visited notification sources.

According to an embodiment, a user's interaction with client computing device 102 and displayed notifications can be used to provide suggested notification sources to the user. A suggested notification source is a notification source from which the user may be interested in receiving notifications based on an analysis of the notification sources that the user has already registered or subscribed to. Notification application 106 can analyze the kinds of notifications received and determine which kinds of information may be of interest to a user. For example, if a user has subscribed to receive notifications from a sports news website, notifications application 106 can analyze the user's interaction with the sports website in order to suggest other notification sources which may be of interest to the user. In this example, other notification sources that may be suggested to the user may include notification sources related to sporting event tickets, sports blogs, or the user's favorite sports teams. In this way, a user may be alerted to notification sources of interest and presented with the option to subscribe or register to receive notifications from the suggested notification sources.

The suggested notification sources are identified based on characteristics of the user activity or by extracting information from stored notifications, according to an embodiment. The characteristics of a user's interactions with client computing device 102 is analyzed and used as criteria for a model, similar to the model discussed above with respect to importance scores. Based on the user's interactions, a profile of the user can be created which identifies the interests of the user at certain times. The profile is a log which can include keywords that have been extracted from notifications. These keywords can be assigned values or percentages. The values or percentages serve as indicators for browser 104 of the types of notification sources to suggest and also when to suggest these notification sources. According to another embodiment, the generated notifications can be analyzed and information including keywords and the assigned importance score can be extracted and used to generate the profile. When the profile is generated, an Internet search can be performed for suggested notification sources that may be of interest to the user. Once a suggested notification source is identified, the URL associated with the notification source is retrieved and used for display in a list of suggested notification sources.

In an embodiment, notification application 106 performs a search of the notifications database and retrieves notifications for display. According to an embodiment, notification application 106 can determine how the notifications are displayed based on the model. The model may be applied to each notification within the notification database and the importance score output by the model can be used to determine when to display the notifications. It can be determined, for example, that notifications with the five highest associated importance scores should be displayed, according to an embodiment. In another embodiment, it may be determined that notifications from a predetermined set of notification sources should always be displayed while all other notifications should only be displayed if the associated importance score satisfies a predefined threshold. One of skill in the art will understand that other rules for displaying notifications may be used. For example, it may be determined that notifications with associated importance scores above a certain threshold should be retrieved, and if none of the scores are above the threshold then no notifications will be displayed or notifications with the highest associated importance scores are displayed.

Notifications may be displayed in a viewing area of browser 104, according to an embodiment. For example, in response to the generation of an importance score for each notification received or generated, the notifications may be displayed to a user in a dedicated first position of browser 104. Additionally, a list of suggested notification sources, as discussed above, may be provided to a user in a dedicated second position of browser 104. A user may then interact with the notification or list of suggested notification sources in order to learn more information. For example, a user may select a notification and in response, the notification source associated with the notification may be loaded in a tab of the browser window. Alternatively, a user may select a suggested notification source and a short description of the notification source may be provided. The user may also be presented with an option to subscribe or register to receive notifications from the selected notification source. Upon opting to receive notifications from a suggested notification source, the user will be presented with notifications from the suggested notifications in a similar manner as discussed above.

Client computing device 102 is a processor-based electronic device that is manipulated by a user and is capable of requesting and receiving data from notification source servers 110-1, 110-2 . . . 110-N over network 108 and communication channels 114-1, 114-2 . . . 114-N. Examples of client computing devices include, but are not limited to, a computer, workstation, distributed computing system, computer cluster, embedded system, standalone electronic device, networked device, mobile device (e.g. mobile phone, smart phone, navigation device, tablet or mobile computing device), rack server, set-top box, or other type of computer system having at least one processor and memory. Such a client computing device may include software, firmware, hardware, or a combination thereof. Software may include one or more applications and an operating system. Hardware can include, but is not limited to, a processor, memory, and user interface display. Client computing device 102 typically includes an application, such as browser 104. A user may utilize browser 104 to request data from notification source servers 110-1, 110-2 . . . 110-N, such as web-page contents over network 108. For example, a request for data from notification source server 110-1, 110-2 . . . 110-N may be sent by browser 104 of client computing device 102 in response to a URL request from a user. In response to the request, notification source servers 110-1, 110-2 . . . 110-N delivers data within resource databases 112-1, 112-2 . . . 112-N to client computing device 102. When client computing device 102 receives data from notification source servers 110-1, 110-2 . . . 110-N, client computing device 102 uses browser 104 to display the data to the user.

Notification application 106, or any combination of its components, may be part of or may be implemented with a client computing device. Although notification application 106 is described herein as operating in conjunction with a browser, one of skill in the art will recognize that notification application 106 may instead be implemented as a stand-alone application on client computing device 102.

Network 108 may be any network or combination of networks that can carry data communications. Such a network 108 may include, but is not limited to, a local area network, metropolitan area network, and/or wide area network such as the Internet. Network 108 can support protocols and technology including, but not limited to, World Wide Web (or simply the “Web”), protocols such as a Hypertext Transfer Protocol (“HTTP”) protocols, and/or services. Intermediate web servers, gateways, or other servers may be provided between components of the system shown in FIG. 1, depending upon a particular application or environment.

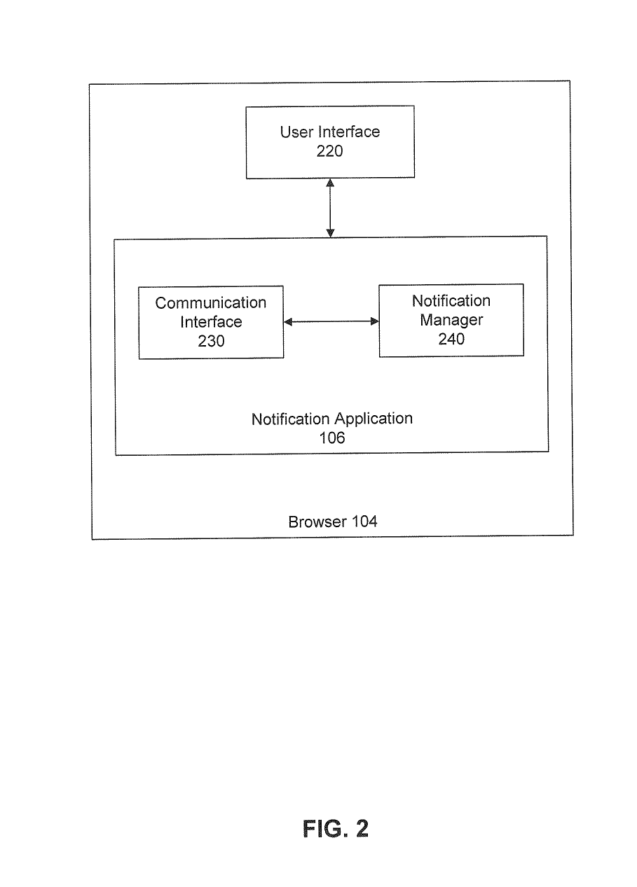

FIG. 2 is an illustration of a browser 104, according to an embodiment. Browser 104 includes notification application 106 communicatively coupled to user interface 220. Notification application 106 includes communication interface 230 and notification manager 240. Notification application 106 may be configured to receive, aggregate, and display notifications for browser 104.

In operation, communication interface 230 is configured to establish a plurality of communication channels between browser 104 and one or more notification source servers. The plurality of communication channels are established in response to input received from user interface 220. User interface 220 is the user interaction area of browser 104. For example, user interface 220 may provide a toolbar that includes a navigation field and a viewing area which provides a display of a website. The navigation field enables a user to enter a URL and request a website to be displayed in a viewing area of browser 104. Additionally, user interface 220 may provide a browser toolbar that provides options for a user to register or subscribe to receive notifications from a website displayed in the viewing area of browser 104 or from a website associated with a URL provided by the user.

In an embodiment, there is a one-to-one mapping between the plurality of communication channels and a plurality of notification sources. For example, the user may utilize browser 104 to generate 1 . . . N subscription or registration requests to receive notifications from 1 . . . N notification sources. For example, a user may navigate to a website by entering the URL in the navigation field. Once the website is displayed the user may register to receive notifications from the website by using a registration option provided by a browser toolbar or by selecting a registration option provided by the website. When a user selects the registration option provide by the browser toolbar, a registration request message can be generated and sent to the server hosting the displayed website. The registration request message can include encrypted user identification information such as an IP address associated with the user's client computing device or a unique user name and key which identifies the user. In response to receipt of the request message, a communication channel is established and the website can provide notifications to the user when content of the website has changed. Alternatively, a user may select a registration option provided by the displayed website. In response to such a selection, the website generates a message which is received by browser 104. Browser 104 authenticates the registration request and in response sends similar encrypted user identification, as discussed above, to the server hosting the website. A communication channel is then established between browser 104 and the website. According to an embodiment, a user may register or subscribe to receive different forms of information related to a change in content of a website or a status update of a website. For example, a user may register to receive notifications from a website supported by a notifications API. Alternatively, a user may subscribe to receive an RSS feed from a website which provides RSS feeds. Once a user registers or subscribes to receive notifications from a notification source, a list of all registration and subscription requests is stored by browser 104. In this way, a user may receive notifications associated with a notifications source without navigating to the website.

Communication interface 230 is configured to analyze the communication channels established in response to the user input from user interface 220. Communication interface 230 analyzes the established communication channels in order to determine whether there has been any change in the content for the websites associated with registration or subscription requests. As discussed above, when a registration or subscription request is generated in response to user input from user interface 220, the server associated with the URL returns a response message to browser 104. The response message completes a handshake process and sends an indication to notification manager 240 to receive or generate notifications when appropriate.

In an embodiment, notification manager 240 is configured to detect a status update of a web page supported by a notifications API. For example, upon receipt of the initial response message from a web server in response to a URL request, notification manager 240 can read the header of the response message. The header of the response message may include a notifications API indicator value which indicates whether the website associated with the URL is supported by a notifications API. In this example, communication interface 230 is then configured to analyze the established communication channels for notifications generated and sent by the web server associated with the URL.

As discussed previously, a website or notification source supported by a notifications API must leverage certain functions of the notifications API in order to interact with notification manager 240. For example, the web developer may be responsible for setting the notifications API indicator value in the source code of the website. Notification manager 240 may then extract and read the notifications API indicator value. Additionally, a web developer of a website supported by a notifications API may need to include certain functionality within the source code of the website, such as functionality to check whether a user has granted permission to receive notifications and functionality to generate a notifications message including a notifications title and notifications summary.

According to an embodiment, a developer of a notification source may generate or select custom notification templates for notification messages leveraging the notifications API. For example, all notifications from a news-based website or notification source may be formatted to include certain graphics or animations along with certain background colors or fonts. A developer may generate or select templates with different fields that specify the inclusion of information, such as a notifications title, notifications summary, or a graphical image or video and also specifies the style, format, and color-scheme for the notification message. The developer can call the API method associated with creation of a notification and pass all fields and parameters into the method in order to generate a custom notifications message. The notification message is then sent from the server to the client computing device running notification manager 240 via a push message. A push message is a mechanism to send data from a server to a browser.

Once a notification is generated by a website or notification source, notification manager 240 receives the notification via the push message and displays the notification in a viewing area of the browser of client computing device. The notification messages are displayed using the template and format selected by the developer.

In another embodiment, a user may be provided with a generated notification in response to subscribing to receive a RSS feed from a notification source. Notification sources which provide RSS feeds publish information about recent changes to content in an XML document that can be accessed by browser 104. The XML document includes a list of the changes to the notification source. Communication interface 230 is configured to analyze the XML documents for all subscribed RSS feeds. When an update is published by a notification source and the XML document is updated, communication interface 230 retrieves the updated information and provides it to notification manager 240. Notification manager 240 can then generate a custom notification using the custom templates discussed above.

According to an embodiment, once a notification is generated by notification manager 240, the notifications are stored in a database. Notification manger 240 is configured to generate an importance score for each stored notification. An importance score indicates the probability that a user desires to view a notification associated with a notification source. In an embodiment, characteristics of a user's interaction with browser 104 and the client computing device running browser 104 can be used to determine an importance score for a notification. For example, notification manager 104 can maintain a log of the websites most frequently visited by the user recently (e.g. the previous 7 days) and assign higher importance scores to these websites. Alternatively, a user may visit certain websites only at certain times during the day. Notification manager 204 can analyze this user behavior and adjust importance scores based on the time of day and day of the week. For example, a user may only be interested in being notified of stock price fluctuations when the market is open between 9:30 am and 4 pm ET. Thus, during the hours of 9:30 am and 4 pm ET, notifications associated with the stock market can be assigned a relatively high importance score (e.g. 90%). At all other times of the day, the notifications associated with the stock market are given a lower priority and thus assigned a relatively low importance score (e.g. 10%). In another embodiment, a user may specify that notifications are displayed only if the associated importance score meets a predetermined threshold. For example, a user may configure notification manager 240 to only display notifications with an associated importance score above 75%.

According to another embodiment, notification manager 240 can maintain a history log of how often the user clicks on notifications from each notification source. In this way, and in combination with other user activity, browser notification application 106 is able to learn and understand which notifications tend to be more interesting or important to the user. Other user activity that may be factored into the generation of an importance score can include: whether browser 104 is in the background or minimized and the user is utilizing another application on the client computing device, whether a user is watching a video within or outside the browser, whether a user is working on an important task on the client computing device and does not want to be disturbed, and whether the browser is in a full screen or presentation mode. All of the user interactions with the client computing device and browser 104 described above can determine an initial importance score and how an importance score is adjusted. A user may preconfigure notification manager 240 to adjust importance scores based on certain user interactions. For example, the user may preconfigure notification manager 240 to assign low importance scores or adjust importance scores of notifications downward, when the user is showing a presentation on the client computing device. In this scenario, the user may not want to see any notifications until the presentation is complete.

It is noted that embodiments are not limited to the examples of characteristics of user interaction discussed above, but are instead applicable to other types of user interaction with a client computing device as would be apparent to persons skilled in the art based on the teachings provided herein. Those skilled in the art with access to the teachings provided herein will recognize additional modifications, applications, and embodiments within the scope thereof and additional fields in which the embodiments would be of significant utility. For example, notification manager 240 can also utilize user interaction such as a keyboard or mouse inputs to determine when a user is idle versus busy. When a user is deemed busy, notification manager 240 can be configured to detect and identify any important, real time notifications that are displayed and may be missed by the user. In such a scenario, these notifications can be redisplayed when the user is more likely to see them.

Notification manager 240 can combine different characteristics of user interaction with a client device when determining importance scores for notifications, according to an embodiment. For example, notification manager 240 can create a log (not shown) of all user interaction with the client device and browser 104. Notification manager 240 can create different combinations of data that can be used as criteria for a model in order to determine an importance score for a notification. For example, combinations of data can include, among other factors, information related to the characteristic of the user interaction with the client computing device, a preconfigured user setting, and a prior user selection of a notification.

The combinations of data are used as criteria by notification manager 240 in order to generate a model. The output of the model may be used to determine which notifications to display, when to display certain notifications, and/or how long to display a notification to a user within a viewing area of browser 104. During the generation of a model, a standard machine learning or statistical technique may be used to determine an importance score or the probability that a user desires to see a notification from a notification source. Any of several well-known techniques may be used to generate the model, such as logic regression, boosted decision trees, random forests, support vector machines, and winnow learners. The model generates a probability that a user desires to see a notification, according to an embodiment.

An algorithm can be used to generate different importance scores for each browser notification. The algorithm can assign importance score values in the range of 0% to 100%, for example, where 100% indicates that a user definitely wants to see a notification from a particular notification source. For example, a user may want to receive notifications from a notification source at the same time every day. Thus, browser notification application 106 may provide the user with notifications settings, which the user may adjust to identify and set the priority of notifications. Therefore, at the particular time of day specified by the user, the notifications desired can be assigned the highest importance scores. In this way, the importance scores for notifications are dynamic and adjust according to changes in user interaction. In another embodiment, a user may identify certain notifications as always important and thus always displayed. In such a scenario, the importance score for the notification is static and can be set to always remain 100%. In this example, the importance score for the identified notifications would not change unless modified by the user.

Once an importance score is determined for all notifications, notifications are displayed to the user in a viewing area of browser 104. For example, the notifications can be displayed in a first position of browser 104 to the right of a displayed website. Alternatively, a user may specify that the notifications are displayed in a different location of the viewing area or in a different window, according to an embodiment. As discussed above, the importance scores for a notification can determine when a notification is displayed, an order in which the notifications are displayed, and a duration of display of the notification. For example, a user may specify that they only want to see a predetermined number of notifications at once (e.g. 5). In this scenario, the notifications with the five highest importance scores can be displayed first. Additionally the notifications with a higher priority or importance score can be displayed for a significant amount of time longer than notifications with lower importance scores. When a notification is displayed, a user has the option to select the notification and, in response, the website associated with the notification source may be displayed and the new content shown. Once a notification is removed from the viewing area, either through selection of the notification or by the exceeding of a duration time threshold for the notification, additional notifications are retrieved from the database and displayed.

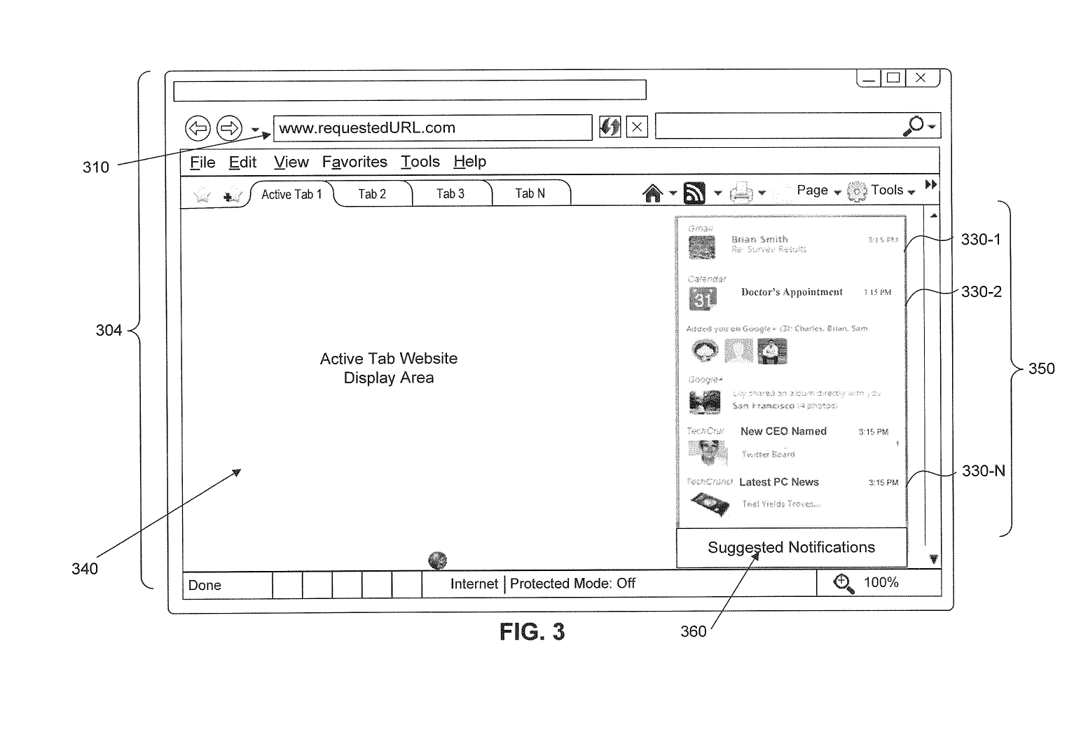

FIG. 3 illustrates a display view of a browser, according to an embodiment. FIG. 3 includes a browser 304 displaying a website in website display area 350. As discussed previously, a website may be displayed in response to a user making a URL request. According to an embodiment, a user can make a URL request using navigation field 310 of browser 304. For example, a user may type in a protocol and server name such as “http:://www.requestedURL.com.” In response, the server hosting the contents of the web page, “www.requestedURL.com”, will send a response message including the contents to be displayed. Browser 304 retrieves the response message and formats the contents for display in website display area 340. Once the user has navigated to the requested URL, the user may choose to register or subscribe to receive notifications from the website. In this example, the displayed website can be a website supported by a notifications API or a website that provides RSS feeds. In either type of website, information regarding a change in content of the website is sent to the user.

Once a registration or subscription request is generated by the user, the website is examined by browser 304 for notifications or RSS feed updates, according to an embodiment. If a notification is sent by a website supported by a notifications API, the notification is received by browser 304 via a push message and displayed. The notifications are displayed in a custom template or format selected by a developer of the website. If an RSS feed is detected, the information regarding the RSS feed update is received and used to generate the custom notifications. The custom notifications are created and then stored by browser 304 prior to display to the user. As discussed previously, an importance score is determined for each of the notifications and the importance score determines when a notification is displayed.

Notification viewing area 350 is used to display notifications based on the importance score. As illustrated, notification viewing area 350 can display notifications 330-1, 330-2 . . . 330-N. Each notification 330-1, 330-2 . . . 330-N is generated using a custom template. The custom template can determine background colors, text colors, font types, font sizes, graphics, or animations for a notification 330-1, 330-2 . . . 330-N. For example, the features of the custom template may be set by a user. The user may specify that certain notifications are formatted in a particular manner. As illustrated, notifications 330-1, 330-2 . . . 330-N have been formatted with different custom templates that result in the notifications appearing differently to the user. Notifications 330-1, 330-2 . . . 330-N are displayed in an order based on the associated importance score, according to an embodiment. For example, notification 330-1 can have the highest associated importance score and is displayed as the first notification. In this way, notifications of higher importance are always presented to the user first.

According to an embodiment, a user's interaction with the client device and notifications 330-1, 330-2 . . . 330-N can be used to provide suggested notification sources 370-1, 370-2 . . . 370-N. A suggested notification source is a potential notification source in which the user may desire to register or subscribe to receive notifications. Based on the kinds of information displayed by notifications 330-1, 330-2 . . . 3 30-N, suggested notification area 360 can be populated with a list of suggested notification sources. For example, if a user has subscribed to receive notifications from a travel website which generated a notification 330-1, 330-2 . . . 330-N, browser 304 can analyze the user's interaction with any notifications associated with the travel website and suggest other notification sources which may be of interest to the user. In this example, other notification sources that may be suggested to the user may include notification sources related to weather or tourism. In this way, a user is provided with notification sources of interest and presented the option to subscribe or register to receive notifications from the suggested notification sources displayed in suggested notification area 360. Upon registering to receive notifications from a suggested notification source, any notifications generated by the selected notification source is also displayed in notification viewing area 350 based on an assigned importance score.

According to an embodiment, browser 304 can analyze characteristics of user behavior and adjust importance scores and suggested notification sources accordingly. In the example above, a user may only be interested in getting notified of travel information during the weekend. Thus, during the weekend, notifications associated with the travel website are assigned a high importance score. Accordingly, suggested notification sources related to the travel website will only be suggested during the weekends.

According to an embodiment, a user may configure browser 304 to provide notifications on a periodic basis. For example, browser 304 may be configured to display new notifications at 2 minute intervals. In another embodiment, a user may enable or disable notifications. For example, a user may set an option to only receive notifications for the notification source associated with notification 330-1.

In an embodiment, each of the constituent parts of notification system 100 may be implemented in hardware, software, firmware, or any combination thereof Likewise, modules or instructions that constitute operative parts of embodiments may utilize any type of structured memory, including a persistent memory. In examples, each data storage infrastructure may be implemented as a relational database.

It should be noted that computer-readable medium storage embodiments may include any physical medium which is capable of having instructions encoded thereon that may subsequently be used by one or more processors to implement methods described herein. Example physical media may include floppy discs, optical discs (e.g. CDs, mini-CDs, DVDs, HD-DVD, Blu-ray), hard drives, punch cards, tape drives, flash memory, and memory chips. However, any other type of tangible storage medium that can serve in the role of providing instructions to one or more processors may be used to store the instructions in these embodiments.

Overview of the Method

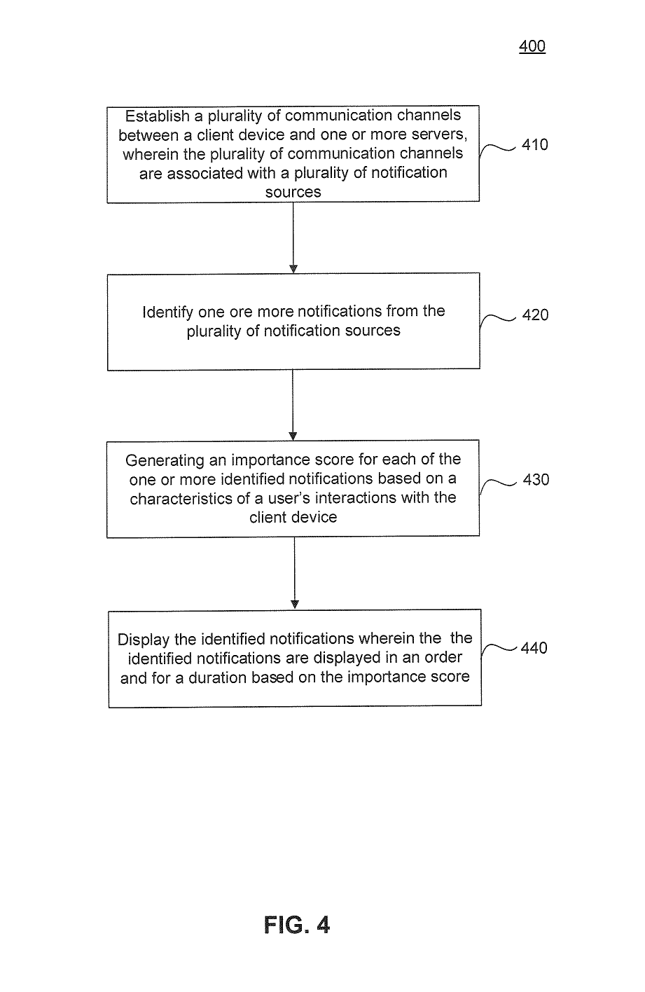

FIG. 4 is a flow diagram of an example method of operation for providing notifications, according to embodiment.

In stage 410, a plurality of communication channels is established. For example, a plurality of communication channels may be established by browser 104 on client computing device 102. A communication channel is established between a client and a notification source server in response to a user registering or subscribing to receive notifications. A notification includes content updates that take place at the notification source server. In an embodiment, there is a one-to-one mapping between the plurality of communication channels and a plurality of notification sources. For example, the user can generate 1 . . . N subscription or registration requests to receive notifications from 1 . . . N notification sources via the plurality of communication channels.

At stage 420, one or more notifications are identified. For example, the one or more notifications are identified by browser 104 on client computing device 102. When new content is generated by a notification source server, the new content can be sent to the client computing device as a notification or as an RSS feed. A notification source supported by a notifications API can generate its own notifications which are sent to the client computing device via a communication channel. Alternatively, a notification source which provides an RSS feed can publish changes to content through an XML document associated with the RSS feed. Upon receipt of this information, the browser generates a custom notification based on custom templates. The custom templates determine how the information of a notification is formatted and eventually displayed to a user.

At stage 430, an importance score for each of the one or more identified notifications is generated. For example, an importance score for the one or more notifications is generated by browser 104 on client computing device 102. An importance score is a value assigned to a notification which serves an indication of how likely or probable a user desires to view notifications from the associated notification source. An importance score is calculated based on a characteristic of a user's interactions with the client computing device. The characteristics of a user's interactions with the client device are used as criteria for a model. Based on the model and criteria, an importance score for each generated notification is determined and the notifications may be displayed to the user at a time, in an order, and for a duration based on the importance score. A standard machine learning or statistical technique may be used to generate an importance score or the probability that a user desires to see a notification from a notification source, according to an embodiment. According to an embodiment, a change in the characteristics of the user interaction can adjust the importance scores associated with notifications. For example, factors such as time of day or a user utilizing another application can impact and adjust importance scores associated with notifications.

At stage 440, the one or more notifications are displayed in a viewing area of the client device. For example, the one or more notifications are identified by browser 104 on client computing device 102. As discussed above, the importance score determines when a notification is displayed in addition to an order of display and duration of display of the notification. In general, notifications with the highest importance scores are displayed to the user first and for an adequate amount of time so that is likely to be seen by the user. As the importance score associated with a notification decreases, the notification can be placed towards the end of a list of displayed notifications and/or displayed for a shorter period of time. Users can select any displayed notifications and display the notification source or website associated with the notification.

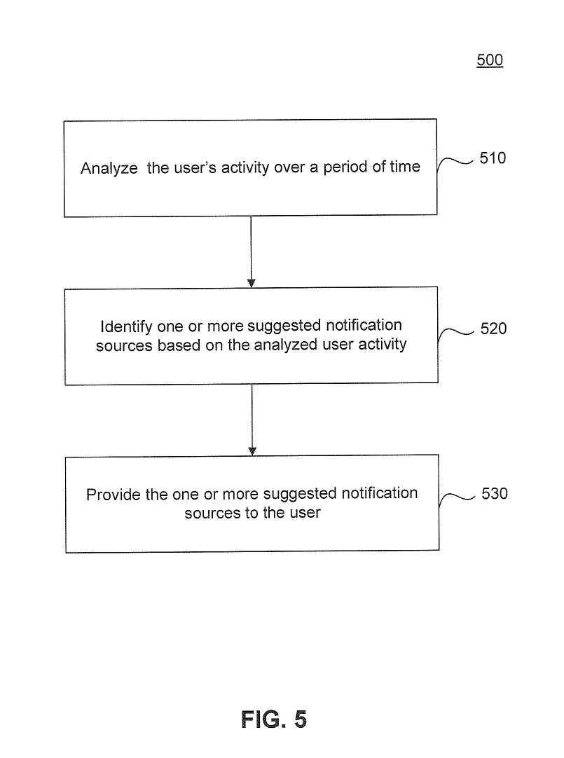

FIG. 5 is a flow diagram of an example method of suggesting notification sources, according to embodiment.

In stage 510, characteristics of the user's activity are analyzed over a period of time. For example, characteristics of the user's activity are analyzed by browser 104 on client computing device 102. Characteristics of a user's interaction with the client computing device or browser can be analyzed in order to provide suggested notification sources to the user. A suggested notification source is a notification source from which the user may be interested in receiving notifications based on an analysis of the characteristics of the user's interactions. The kinds of notifications received may be analyzed, and it may be determined which kinds of information may be of interest to a user at specific times of day. For example, if a user has subscribed to weather or traffic update notifications from a website, the user's interaction with these notifications or the website can be analyzed. Thus, it may be determined that the user only views the website or notification generated by the website during the morning hours. All such characteristics of the user's behavior and interaction are analyzed by the client computing device, according to an embodiment.

In stage 520, one or more suggested notification sources are identified based on the analyzed user activity. For example, the one or more suggested notification sources can be identified by browser 104 on client computing device 102. All of a user's interactions with the client computing device can be analyzed and used as criteria in a model, similar to the model discussed above with respect to importance scores. Based on the user's interactions, a profile of the user can be created. The profile of the user indicates the interests of the user at certain times. The profile can include keywords that have been extracted from notifications and these keywords can be assigned values using a scheme similar to the generation of importance scores. In an alternative embodiment, the generated notifications can be analyzed and information including keywords and the assigned importance score can be extracted and used to generate the profile. Once the profile is generated, it is used to perform searches of the Internet for relevant or suggested notification sources that may be of interest to the user. In the example above, notification sources which may be relevant to traffic or weather updates include other travel or map-based websites or general news-based websites. Once a relevant or suggested notification source is identified, the URL associated with the notification source is retrieved.

In stage 530, the one or more suggested notification sources are provided to the user. For example, the one or more suggested notification sources are provided to the user by browser 104 on client computing device 102. A list of suggested notification sources can be provided to a user in a dedicated second position of the browser. A user may then interact with the list of suggested notification sources in order to learn more information. For example, a user may select a suggested notification source and a short description of the notification source may be provided. The user can also be presented with an option to subscribe or register to receive notifications from the selected notification source. Upon opting to receive notifications from a suggested notification source, the user is presented with notifications from the suggested notification source.

Computer System

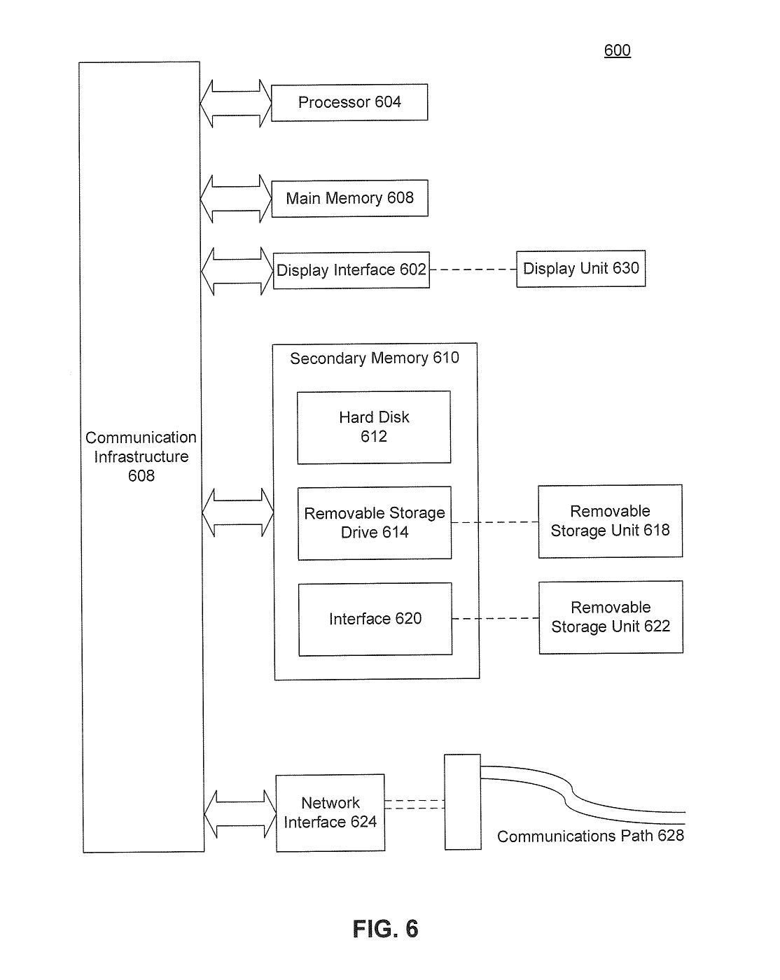

Various aspects of the present invention can be implemented by software, firmware, hardware, or a combination thereof. Embodiments may be implemented via a set of programs running in parallel on multiple machines. FIG. 6 illustrates an example computer system 600 in which the embodiments, or portions thereof, can be implemented as computer-readable code. For example, browser notification system 100 carrying out methods 400 and 500 of FIG. 4 and FIG. 5 respectively can be implemented in system 600. Various embodiments of the invention are described in terms of this example computer system 600.

Computer system 600 includes one or more processors, such as processor 604. Processor 604 is connected to a communication infrastructure 606 (for example, a bus or network).

Computer system 600 also includes a main memory 608, preferably random access memory (RAM), and may also include a secondary memory 610. Secondary memory 610 may include, for example, a hard disk drive and/or a removable storage drive. Removable storage drive 614 may include a floppy disk drive, a magnetic tape drive, an optical disk drive, a flash memory, or the like. The removable storage drive 614 reads from and/or writes to removable storage unit 618 in a well-known manner. Removable storage unit 618 may include a floppy disk, magnetic tape, optical disk, etc. which is read by and written to by removable storage drive 614. As will be appreciated by persons skilled in the relevant art(s), removable storage unit 618 includes a computer readable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 are in the form of non-storage signals which may be electronic, electromagnetic, optical, or other signals capable of being received by communications interface 624. These signals are provided to communications interface 624 via a communications path 626. Communications path 626 carries signals and may be implemented using wire or cable, fiber optics, a phone line, a cellular phone link, an RF link or other communications channels.

In this document, the term “computer readable storage medium” is used to generally refer to media such as removable storage unit 618, removable storage unit 622, and a hard disk installed in hard disk drive 612. Computer readable storage medium can also refer to one or more memories, such as main memory 508 and secondary memory 610, which can be memory semiconductors (e.g. DRAMs, etc.). These computer program products are means for providing software to computer system 600.

Computer programs (also called computer control logic) are stored in main memory 608 and/or secondary memory 610. Computer programs may also be received via communications interface 624. Such computer programs, when executed, enable computer system 600 to implement the embodiments as discussed herein. In particular, the computer programs, when executed, enable processor 604 to implement the processes of embodiments of the present invention, such as the steps in the methods discussed above. Accordingly, such computer programs represent controllers of the computer system 600. Where embodiments are implemented using software, the software may be stored in a computer program product and loaded into computer system 600 using removable storage drive 614, interface 620, or hard drive 612.

Embodiments may be directed to computer products comprising software stored on any computer readable storage medium. Such software, when executed in one or more data processing device, causes a data processing device(s) to operate as described herein.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from a content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

### CONCLUSION

The Summary and Abstract sections may set forth one or more but not all example embodiments of the present invention as contemplated by the inventor(s), and thus, are not intended to limit the present invention and the appended claims in any way.

Embodiments have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described example embodiments, but should be defined only in accordance with the following claims and their equivalents.

What is claimed is:

1. A computer-implemented method comprising:
establishing, by a client device, a plurality of communication channels between the client device and one or more servers, wherein the plurality of communication channels are associated with a plurality of notification sources for a web application;
identifying, by the client device, one or more notifications from the plurality of notification sources;
generating an importance score for each of the one or more identified notifications based on a characteristic of a user's interactions with the client device; and
displaying, by the client device, the identified notifications, wherein the identified notifications are displayed in an order and for a duration based on the importance score.

2. The method of claim 1, wherein generating an importance score comprises:
generating criteria for a model based on at least one of (i) information related to the characteristic of the user interaction with the client device, (ii) a preconfigured user setting, and (iii) a prior user selection of a notification, wherein the model assigns the importance score for each of the identified notifications.

3. The method of claim 1, wherein the identified notifications are displayed based on the importance score of an identified notification meeting a predetermined importance factor threshold.

4. The method of claim 1, wherein the characteristic of a user's interaction includes at least one of a visitation frequency to the one or more notification sources, a visitation pattern to the one or more notification sources, a clickthrough rate for notifications associated with the plurality of notification sources, or a state of the web application based on a user's most recent interaction with the web application.

5. The method of claim 1 further comprising:
analyzing, by the client device, the user's interaction with the client device over a period of time;
identifying, by the client device, one or more suggested notification sources based on the analyzed user interaction; and
providing, by the client device, the one or more suggested notification sources to the user.

6. The method of claim 5, further comprising:
detecting a user interaction with the provided one or more suggested notification sources; and
establishing one or more additional communication channels based on the user interaction, wherein the additional communication channels enable the one or more suggested notification sources to provide notifications to the client device.

7. The method of claim 1, further comprising:
updating the displayed notifications based on at least one of a generation of new content from the plurality of notification sources or a change in the user's interaction with the client device.

8. The method of claim 1, wherein establishing a plurality of communication channels comprises:
sending an encrypted user identification to the plurality of notification sources in response to a user request to receive notifications from the plurality of notification sources; and
enabling the plurality of notification sources to send a notification to the client device.

9. The method of claim 1, wherein establishing a plurality of communication channels comprises:
receiving one or subscription requests for the plurality of notification sources.

10. The method of claim 1, wherein identifying one or more notifications comprises:
detecting status updates from the plurality of notification sources; and
receiving one or more notification update messages from the one or more servers.

11. The method of claim 1, wherein displaying comprises:
retrieving the identified notifications; and
presenting the identified notifications based on one of a predetermined notification template or a custom notification template.

12. The method of claim 1, further comprising:
detecting a user interaction with one of the displayed notifications, wherein the user interaction is a selection of the displayed notification; and
displaying content associated with the displayed notification within a tab of the web application.

13. A system comprising:
a computing device comprising a processor and memory;
a communication interface, implemented on the computing device, and configured to establishing a plurality of communication channels, wherein the plurality of communication channels are associated with a plurality of notification sources for a web application; and
a notification manager, implemented on the computing device, and configured to identify one or more notifications from the plurality of notification sources, generate an importance score for each of the one or more identified notifications based on a characteristic of a user's interactions with the client device, and display the identified notifications, wherein the identified notifications are displayed in an order and for a duration based on the importance score.

14. The system of claim 13, wherein the notification manager is further configured to generate criteria for a model based on at least one of (i) information related to the characteristic of the user interaction with the client device, (ii) a preconfigured user setting, and (iii) a prior user selection of a notification, wherein the model assigns the importance score for each of the identified notifications.

15. The system of claim 13, wherein the notification manager is further configured to display the identified notifications based on the importance score of an identified notification meeting a predetermined importance factor threshold.

16. The system of claim 13, wherein the characteristic of a user's interaction includes at least one of a visitation frequency to the one or more notification sources, a visitation pattern to the one or more notification sources, a clickthrough rate for notifications associated with the plurality of notification sources, or a state of the web application based on a user's most recent interaction with the web application.

17. The system of claim 13, wherein the notification manager is further configured to analyze the user's activity over a period of time, identify one or more suggested notification sources based on the analyzed user activity, and provide the one or more suggested notification sources to the user.

18. The system of claim 17, wherein the communication interface is further configured to receive a signal indicating a user interaction with the provided one or more suggested notification sources, and establish one or more additional communication channels based on the user interaction, wherein the additional communication channels enable the one or more suggested notification sources to provide notifications to the client device.

19. The system of claim 13, wherein the notification manager is further configured to update the displayed notifications based on at least one of a generation of new content from the plurality of notification sources or a change in the user's activity of the client device.

20. The system of claim 13, wherein the communication interface is further configured to send an encrypted user identification to plurality of notification sources in response to a user request to receive notifications from the plurality of notification sources and enable the plurality of notification sources to send a notification.

21. The system of claim 13, wherein the communication interface is further configured to receive one or subscription requests for the plurality of notification sources.

22. The system of claim 13, wherein the notification manager is further configured to detect status updates from the plurality of notification sources, and receive one or more notification update messages.

23. The system of claim 13, wherein the notification manager is further configured to retrieve the subset of the identified notifications, and present the subset of the identified notifications based on one of a predetermined notification template or a custom notification template.

24. The system of claim 13, wherein the communication interface is further configured to detect a user interaction with one of the displayed notifications, wherein the user interaction is a selection of the displayed notification, and display content associated with the displayed notification within a tab of the web application.

25. A computer-readable storage medium storing instructions executable by one or more computers which, upon execution, cause the one or more computers to perform operations comprising:
establishing a plurality of communication channels, wherein the plurality of communication channels are associated with a plurality of notification sources for a web application;
identifying one or more notifications from the plurality of notification sources;
generating an importance score for each of the one or more identified notifications based on a characteristic of a user's interactions with a client device; and
displaying the identified notifications, wherein the identified notifications are displayed in an order and for a duration based on the importance score.

26. The computer readable storage medium of claim 25, wherein the instructions cause the processor to further perform:
generating criteria for a model based on at least one of (i) information related to the characteristic of the user interaction with the client device, (ii) a preconfigured user setting, and (iii) a prior user selection of a notification, wherein the model assigns the importance score for each of the identified notifications.

27. The computer readable storage medium of claim 25, wherein the identified notifications are displayed based on the importance score of an identified notification meeting a predetermined importance factor threshold.

28. The computer readable storage medium of claim 25, wherein the characteristic of a user's interaction includes at least one of a visitation frequency to the one or more notification sources, a visitation pattern to the one or more notification sources, a clickthrough rate for notifications associated with the plurality of notification sources, or a state of the web application based on a user's most recent interaction with the web application.

29. The computer readable storage medium of claim 25, wherein the instructions cause the processor to further perform:
analyzing the user's activity over a period of time;
identifying one or more suggested notification sources based on the analyzed user activity; and
providing the one or more suggested notification sources to the user.

30. The computer readable storage medium of claim 29, wherein the instructions cause the processor to further perform:
detecting a user interaction with the provided one or more suggested notification sources; and
establishing one or more additional communication channels based on the user interaction.

31. The computer readable storage medium of claim 25, wherein the instructions cause the processor to further perform:
sending an encrypted user identification to the plurality of notification sources in response to a user request to receive notifications from the plurality of notification sources; and
enabling the plurality of notification sources to send a notification to the client device, wherein the additional communication channels enable the plurality of notification sources to provide notifications to the client device.

32. The computer readable storage medium of claim 25, wherein the instructions cause the processor to further perform:
receiving one or subscription requests for the plurality of notification sources.

33. The computer readable storage medium of claim 25, wherein the instructions cause the processor to further perform:
detecting status updates from the plurality of notification sources; and
receiving one or more notification update messages from the one or more servers.

34. The computer readable storage medium of claim 25, wherein the instructions cause the processor to further perform:
retrieving the subset of the identified notifications; and
presenting the identified notifications based on one of a predetermined notification template or a custom notification template.

35. The computer readable storage medium of claim 25, wherein the instructions cause the processor to further perform:
detecting a user interaction with one of the displayed notifications, wherein the user interaction is a selection of the displayed notification; and
displaying content associated with the displayed notification within a tab of the web application.
